(19) United States
(12) Patent Application Publication
(10) Pub. No.: US 2008/0095873 A1
(43) Pub. Date: Apr. 24, 2008

(54) High Pressure Stranding Die

(76) Inventors: Carl L. Gibbons, Midland, MI (US); Martin H. Tusim, Midland, MI (US); Andrew R. Brush, Ashland, KY (US)

Correspondence Address: The Dow Chemical Company, Intellectual Property Section, P.O. Box 1967, Midland, MI, 48641-1967, US

(21) Appl. No.: 11/795,730

(22) PCT Filed: Mar. 16, 2006
(86) PCT No.: PCT/US06/09841

§ 371 Date: Jul. 20, 2007

Related U.S. Application Data
(60) Provisional application No. 60/663,403, filed on Mar. 18, 2005.

(51) Int. Cl. B29C 47/30

(52) U.S. Cl. 425/4 R; 428/304.4; 524/1

(57) ABSTRACT

A perforated resin extrusion end plate (10) with a curved or arcuate perforated section suitable for use in making extruded foamed polymer strand foam bodies, extruded filled polymer strand articles of manufacture or extruded composites of fibrous organic material and a thermoplastic material such as a wood-plastic composite. The die plate does not fracture under conditions that produce fracturing of a flat perforated die plate with the same perforated area and thickness.

The present invention relates generally to an extrusion die, die plate or end plate, especially a multiple apertured extrusion die, die plate or end plate, suitable for use in making a coalesced polymer strand foam material or as part of a process for converting filled polymer materials or wood/thermoplastic polymer compositions into articles of manufacture. The present invention relates more particularly to a multiple apertured extrusion die, die plate or end plate that has perforated segment surrounded by a perimeter flange portion wherein the perforated segment has either a substantially uniform thickness or a thickness that varies from a minimum at edges of the perforated segment to a maximum at its center. In either case, the multiple aperture extrusion die, die plate or end plate is capable of withstanding an extruder back pressure as high as 800 pounds per square inch (psi) (5.5 Megapascals (MPa)) or, if desired, even higher than 800 psi (5.5 MPa) for an extended period of time without failure due to die, die plate or end plate, fracture in or around one or more of the apertures. The present invention relates still more particularly to such an extrusion die, die plate or end plate, wherein the die, die plate or end plate, has a thickness that minimizes shear heating of a foamable composition as it passes through the apertures when the die, die plate or end plate, is used to make a coalesced polymer strand foam material.

A number of references disclose foamed objects comprising a plurality of coalesced distinguishable extended strands of polymers (strand foams). The references include U.S. Pat. No. (U.S. Pat. No.) 3,573,152; U.S. Pat. No. 3,467,570; U.S. Pat. No. 3,723,586; U.S. Pat. No. 3,954,365; U.S. Pat. No. 3,993,721; U.S. Pat. No. 4,192,839; U.S. Pat. No. 4,801,484; U.S. Pat. No. 4,824,720; U.S. Pat. No. 5,109,029; U.S. Pat. No. 5,110,841; U.S. Pat. No. 5,124,097; U.S. Pat. No. 5,288,740; U.S. Pat. No. 5,405,883; and Patent Cooperation Treaty Application WO 92/16363.

U.S. Pat. No. 3,573,152 teaches preparation of foam by extruding an expandable resin composition through a plurality of holes bored in a die plate 10 (FIG. 2) to form expanding foam strands that fuse together when they come in contact with adjacent expanding foam strands.

U.S. Pat. No. 3,993,721 discloses a process and extrusion die for preparing foam articles of thermoplastic resin, for example polystyrene, having a hard and smooth surface and resembling natural wood. A polymer/blowing agent mixture is extruded through a tiered die plate having a peripheral portion and a protruding interior portion. Each of the portions has defined therein a plurality of apertures, with the aperture density in the peripheral portion being greater than that of the interior portion.

U.S. Pat. No. 4,192,839 relates to a process for producing expanded thermoplastic resin articles. The process employs a nozzle with rows of apertures that are separated on a resin-entering side by a continuous projection.

U.S. Pat. No. 4,548,775 pairs a cooling frame with a die such as that of U.S. Pat. No. 3,573,152. The cooling frame helps shape the foam and, when a cooling medium is circulated through the frame's interior, causes formation of a high density skin layer on the foam body. FIG. (FIG.) 2 of U.S. Pat. No. 4,548,775 shows a conventional, rectangular multi-apertured resin extrusion end plate for a die designated by reference numeral 3.

U.S. Pat. No. 4,801,844 relates to a foam product comprising a plurality of coalesced distinguishable expanded thermoplastic resin foam strands or profiles wherein the foam product includes a high loading of nucleating solids. A “high” loading ranges from 0.5 percent (%) to 50% by weight (wt %), based on total weight of thermoplastic resin. Nucleating solids include carbon black, conductive fibers, particulate flame retardants and pigments.

U.S. Pat. No. 4,824,720 discloses closed cell, coalesced strand foams prepared from non-aromatic olefin polymer resins, especially ethylene polymer resins.

U.S. Pat. No. 5,516,472 relates to a process and an apparatus for combining an organic fibrous material with a thermoplastic material to form a wood-imitating composite. The apparatus includes a stranding die such as that shown in FIGS. 6, 6A, 6B and 6C. As noted in column 10, lines 28-49, the stranding die shown in FIG. 6 is a square-shaped, flat metal plate approximately 1.5 inches (in.) (3.8 centimeters (cm)) thick that includes multiple, substantially round apertures contained within an oblong-shaped area.

A first aspect of the present invention is an integral resin extrusion end plate, preferably an end plate for converting a foamable polymer melt composition into an extruded polymer strand foam or for converting either a filled thermoplastic polymer melt composition or a melt composition that comprises a fibrous material and a thermoplastic polymer into an article of manufacture, the end plate having a first or polymer melt receiving major surface and, spaced apart from and generally parallel to the first major surface, a second or polymer melt discharge major surface, the first and second major surfaces having defined therein a perimeter flange segment that surrounds a radially arcuate segment, each major surface of the radially arcuate segment having a radius of curvature drawn from a center of radius spaced apart from the end plate and, relative to the major surfaces, closer to the second major surface than to the first major surface, the radially arcuate segment having defined therein a plurality of polymer melt flow apertures each of which is in fluid communication with both the first and second major surfaces. The polymer melt may be a foamable polymer melt or a flowable melt comprising a thermoplastic polymer and filler or a flowable melt comprising a fibrous material and a thermoplastic polymer. The fibrous material may be organic, inorganic, and combinations thereof. The end plate, sometimes referred to as a die plate or simply as a die, preferably receives a polymer melt, irrespective of whether it is a foamable polymer melt, a filled thermoplastic polymer melt or a polymer melt composition that comprises a fibrous material and a thermoplastic polymer, by way of a connection to any of an extruder discharge end, a cooler discharge end or a transfer line discharge end. The connection may be direct to one of such discharge ends or indirect by way of a die body adapted to receive the end plate.

In a variation of the first aspect, the major surfaces of the radially arcurate segment have the same radius of curvature, but are drawn from different centers of radius. In other words, the center of radius for the first or polymer melt receiving surface is closer to the second or polymer melt discharge surface than the center of radius for the polymer melt discharge surface. This results in a radially arcuate segment that has a greater thickness in its center portion than at its edge portions. A similar effect may be obtained by using the same center of radius for each major surface but varying the radius of curvature for the first or polymer melt receiving surface in a continuum from a minimum at either edge of the radially arcuate segment through a maximum at the center of the radially arcuate segment to a minimum at the other edge of the radially arcuate segment.

A second aspect of the present invention is a further variation of the first aspect wherein only the first or polymer melt receiving surface has a radially arcuate segment and the second or polymer melt discharge surface is fully planar. In other words, the second or polymer melt discharge surface has no radially arcuate segment. Stated in another way, the second aspect is an integral resin extrusion end plate for an extruded polymer melt strand die, the end plate having a second or polymer melt discharge major surface that is fully planar with a planar perimeter flange section that surrounds a planar perforated segment, and, spaced apart from the second major surface, a first or polymer melt receiving major surface that has a perimeter flange portion that surrounds a convex perforated segment, perforations in the perforated segments having defined therein a plurality of polymer melt apertures that are in fluid communication with both the first and second major surfaces.

A third aspect of the present invention is a coalesced, extruded polymer strand foam body having an as-produced thickness of at least 1 inch (2.5 centimeters) and an as-produced width of at least 11 inches (28 centimeters). The as-produced thickness is desirably at least 2 in. (2.5 cm) and may be as much as 6 in. (15.2 cm). The as produced width is desirably at least 15 in. (38.1 cm) and may be as much as 36 in. (91.4 cm). The body preferably has an as produced thickness within a range of from 1 in. (2.5 cm) to 6 in. (15.2 cm) and an as produced width within a range of from 11 in. (28 cm) to 36 in. (91.4 cm). The coalesced, extruded polymer strand foam body is preferably produced using the integral resin extrusion end plate of either the first aspect (in either variation) or the second aspect and a blowing agent, an inorganic blowing agent such as carbon dioxide (CO2), with or without water, or a chemical blowing agent such as an azodicarbonamide or others described below.

A fourth aspect of the present invention is an article of manufacture comprising a filled polymer material, preferably a filled thermoplastic polymer material, or a composition that comprises an organic fibrous material and a thermoplastic polymer, preferably a wood/plastic composition.

Generally, the dimensions listed for the end plate or die refer to the region of the die that includes the polymer melt apertures. Additional length and width are typically needed to contain the mounting holes to secure the die plate to the extruder or transfer pipe.

The extrusion end plate or die of the present invention, when used with foamable polymer melts, preferably has a length of from 8 inches (in.) (20.3 centimeters (cm)) to 36 in. (91.4 cm), preferably from 15 in. (38.1 cm) to 30 in. (76.2 cm), a width of from 3 in. (7.6 cm) to 9 in. (22.9 cm), preferably from 4 in. (10.2 cm) to 8 in. (20.3 cm), and a thickness of from 0.125 in. (0.3 cm) to 1.5 in. (3.8 cm), preferably from 0.5 in. (1.3 cm) to 1.2 in. (3.0 cm).

The extrusion end plate or die of the present invention, when used with flowable melt compositions, preferably has a length of from 3 in. (7.6 centimeters (cm)) to 48 in. (121.9 cm), preferably from 4 in. (10.2 cm) to 32 in. (81.3 cm) and most preferably 4 in. (10.2 cm) to 12 in. (30.5 cm), a width of from 0.5 in. (1.3 cm) to 6 in. (15.2 cm), preferably from 0.75 in. (1.9 cm) to 4 in. (10.2 cm), and a thickness of from 0.125 in. (0.3 cm) to 1.5 in. (3.8 cm), preferably from 0.25 in. (0.6 cm) to 1.2 in. (3.0 cm).

Extrusion end plates or dies of the present invention that have dimensions within the limits stated above, when subjected to an extruder back pressure of 800 pounds per square inch (psi) (5.5 megapascals (MPa)), are substantially free of fractures between polymer melt apertures whereas a flat extrusion end plate or die having the same dimensions evidences cracking, fractures or both between adjacent polymer melt apertures, especially those apertures that establish an outer boundary of apertures, when subjected to the same extruder back pressure. This difference in behavior becomes increasingly evident as plate or die length and width increase with corresponding increases in number of polymer melt apertures.

Unless otherwise stated herein, a range includes both end points that establish the range. For example, a range of from 2 in. (5.1 cm) to 20 in. (50.8 cm) includes both 2 in. and 20 in.

FIG. (FIG.) 1 is a front elevational schematic illustration of a high pressure stranding die representative of the present invention and designated by reference numeral 10. The polymer melt apertures, as more clearly shown in FIG. 2, have axes that converge toward a point distant from the polymer melt exit surface.

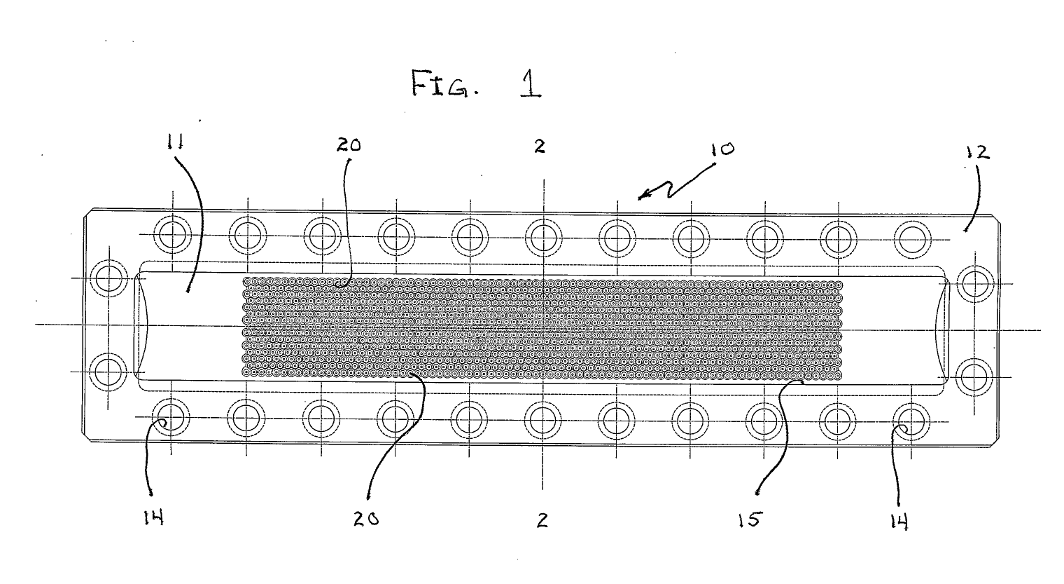

FIG. 2 is an expanded, not-to-scale relative to FIG. 1, side elevation schematic illustration taken along line 2-2 in FIG. 1.

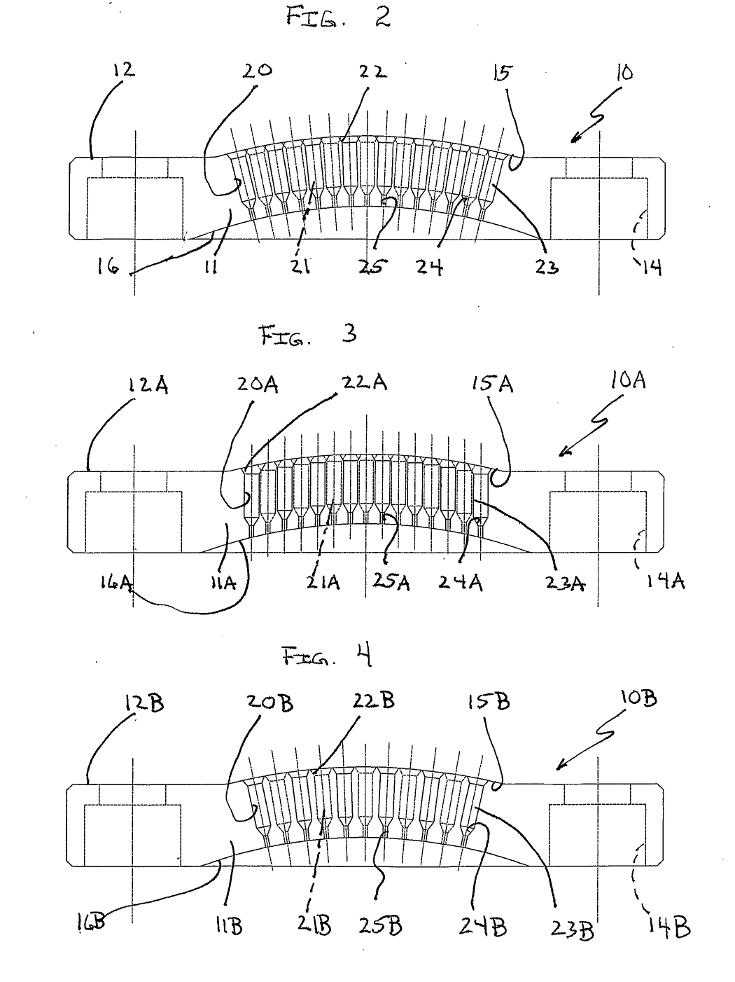

FIG. 3 is an expanded, not-to-scale relative to FIG. 1, side elevation schematic illustration of an alternative, designated by reference numeral 10A, to the extrusion end plate shown in FIG. 2 showing polymer melt apertures with axes that are generally parallel to each other, preferably substantially parallel to each other and more preferably parallel to each other.

FIG. 4 is an expanded, not-to-scale relative to FIG. 1, side elevation schematic illustration of an alternative, designated by reference numeral 10B, to the extrusion end plate shown in FIG. 2 showing a different number of polymer melt apertures and a different converging aperture layout than that shown in FIG. 2 with spacing between apertures that differs from that shown in FIG. 2.

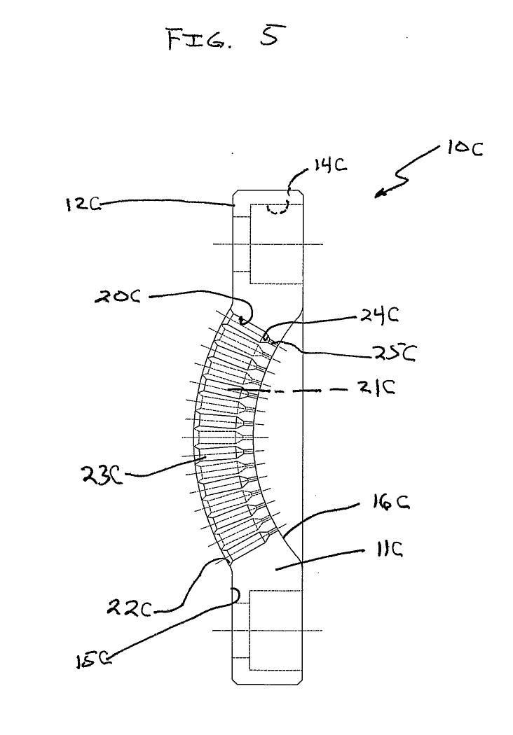

FIG. 5 is an expanded, not-to-scale relative to FIG. 1, side elevation schematic illustration of an alternative, designated by reference numeral 10C, to the extrusion end plate shown in FIGS. 2 through 4 showing converging apertures and a different center of radius or radius of curvature.

Referring now in detail to the Figs. and initially to FIG. 1, reference numeral 10 designates a resin extrusion end plate of the present invention. Variations of numbering in FIGS. 3-5, relative to numbering in FIG. 1, by adding an A for FIG. 3, a B for FIG. 4 and a C for FIG. 5 after a reference numeral means that a feature bearing the reference numeral, for example 20A in FIG. 3, is similar to, but not necessarily identical to, a similar feature in another Fig., for example 20 in FIGS. 1 and 2 or 20B in FIG. 4 or 20C in FIG. 5.

In FIG. 1, a plurality of polymer melt holes or apertures 20 are bored in a rectangular array of columns (parallel to section line 2-2) and rows (perpendicular to section line 2-2) in radially arcuate segment 11 of extrusion end plate 10 in a predetermined configuration. The melt holes or apertures 20 preferably have a regular arrangement, but skilled artisans recognize that the apertures may be configured in many different configurations from a very ordered pattern to one of total randomness. Intermediate between these extremes, a skilled artisan can readily modify aperture diameters, spacing of individual apertures or groups or patterns of apertures, in order to form a semi-regular configuration. A skilled artisan may also modify aperture spacing and grouping to facilitate production of a profiled shape or a near-net shape wherein little, if any, machining or other forming techniques need to be employed to ready a product made using the die plate for its intended end use application.

The apertures 20 preferably have a circular cross-section, but skilled artisans recognize that the apertures may have any other shape known in the art and, if desired, two or more different aperture shapes may be incorporated into a single end plate 10 without departing from the spirit or scope of the present invention. Each aperture 20 has an axis (shown in FIGS. 2 and 3) designated by reference numeral 21. In a column of apertures 20, the axes 21 may be generally parallel to each other as shown in FIG. 3 or they may converge toward a point distant from end plate 10 as shown in FIG. 2. In a row of apertures 20, the axes 21 are generally parallel to each other.

The configuration or array of mounting apertures at least partially determines what shape an extruded polymer body will take after it exits the end plate. For example, a rectangular configuration of holes or apertures will, in the absence of a forming or sizing die, a cooling frame or both, yield a generally rectangular body. “Hole distribution area” or “aperture distribution area”, as used herein, refers to an area of the extrusion end plate that contains the polymer melt holes or apertures 20. By tracing a line through axes of the outermost holes or apertures within the hole distribution area, one approximates the shape that the extruded polymer body will take after it exits the end plate. While the shape is preferably rectangular for most purposes and most shapes will be polygonal if not rectangular, any other shape may be used if desired. In addition, use of a forming or sizing die, a cooling frame or both may alter the shape somewhat from the shape determined by the pattern of apertures 20.

As shown in FIG. 1, extrusion end plate 10 also has defined therein a plurality of mounting apertures 14. Mounting apertures 14 are adapted to receive mounting means (not shown) such as externally screw threaded cap screws that secure extrusion end plate 10 to a polymer melt discharge end of an extruder (not shown).

As more clearly shown in FIGS. 2, 3, 4 and 5, the hole distribution area of integral extrusion end plates representative of the present invention is confined to the radially arcuate segment of the end plates. In other words, none of the apertures or holes 20 (FIGS. 1 and 2), 20A (FIG. 3), 20B (FIG. 4) or 20C (FIG. 5) through which a foamable polymer melt or flowable melt, whichever is appropriate, will pass lie outside the radially arcuate segment. Any apertures or holes 14, 14A, 14B or 14C that are defined, respectively, in perimeter flange segments 12, 12A, 12B or 12C of end plates 10, 10A, 10B or 10C are for the purpose of securing the extrusion end plate to an extruder die body using conventional fastening means rather than as flow channels through which a polymer melt passes. Hereinafter, for ease of reading, a reference to a reference numeral without a paired letter applies equally to FIGS. 1 and 2, neither of which has a reference numeral with a paired letter, and to FIGS. 3-5, each of which has all of its reference numerals paired with a letter, A for FIG. 3, B for FIG. 4 and C for FIG. 5.

Extrusion end plate 10 has a polymer melt receiving surface 15 and a foamable polymer melt exit surface 16 (shown only in FIGS. 2 through 5).

Apertures or holes 20 preferably has a flared or countersunk segment 22 proximate to, and intersecting with, polymer melt or gel receiving surface 15. As more clearly shown in FIGS. 2 through 5, apertures 20 are in fluid communication with both polymer melt receiving surface 15 and polymer melt exit surface 16. Countersunk segment 22 connects into one end of main bore 23 of aperture 20. The other end of main bore 23 preferably tapers into a reduced diameter passageway 25 as shown more clearly in FIGS. 2 through 5. The exit end of main bore 23 preferably has a reduced diameter passageway 25 for reasons of managing pressure drop when processing a foamable polymer melt, but need not have a reduction in diameter when processing a flowable melt.

In operation, extrusion end plate 10 is secured to the polymer melt discharge end of an extruder (not shown) using conventional fastening means such as an externally threaded cap screw (not shown). Extrusion end plate 10 is positioned such that polymer melt receiving surface 15 is proximate to and in operative contact with the polymer melt discharge end of the extruder (not shown) and the polymer melt exit surface 16 is remote from said discharge end. A polymer melt composition (not shown) exits the extruder (not shown) by passing through extrusion end plate 10 via the plurality of apertures 20. In passing through extrusion end plate 10, the polymer melt composition proceeds sequentially through flared segment 22, main bore 23 and optionally reduced diameter passageway 25.

Blowing agents that can be used to make foamable polymer melt compositions suitable for processing using the end plates of the present invention include physical blowing agents and chemical blowing agents. U.S. Pat. No. 6,541,105, the teachings of which are incorporated herein, discloses a variety of both chemical and physical blowing agents at column 4, line 30 through column 5, line 2. Contrary to the limitation of up to 15 wt % of an inorganic blowing agent at column 4, lines 59-61, the present invention allows use of up to 100 wt % of inorganic blowing agent, either singly or in combination.

U.S. Pat. No. 6,844,055 discloses suitable polymers for use in polymer melt compositions at column 10, line 17 through column 11, line 50 and suitable blowing agents for foamable polymer melt compositions at column 12, line 24 through column 13, line 3. Illustrative polymers include polyvinyl chloride, polycarbonates, polyamides, polyimides, polyesters, polyester copolymers, phenol-formaldehyde resins, thermoplastic polyurethanes, biodegradable polysaccharides such as starch, olefin polymers such as polyethylene, including but not limited to low density polyethylene, high density polyethylene and linear low polyethylene, ethylene copolymers, polypropylene, propylene copolymers, and vinyl aromatic polymers and copolymers such as polystyrene. Known blowing agents include one or more of hydrocarbons such as ethane, ethylene, propane, butane, isobutane, pentane, isopentane and cyclohexane; ethers such as dimethyl ether; alcohols such as ethanol; and any of a variety of partially halogenated chlorocarbons, chlorofluorocarbons, fluorocarbons and hydrofluorocarbons; carbon dioxide; water; and noble gases such as argon.

Known chemical blowing agents include azodicarbonamide, azodiisobutyro-nitrile, benzenesulfonhydrazide, 4,4-oxybenzene sulfonyl-semicarbazide, p-toluene sulfonyl semi-carbazide, barium azodicarboxylate, N,N′-dimethyl-N,N′-dinitroso-terephthalanide, trihydrazino triazine and mixtures of citric acid and sodium bicarbonate such as the various products sold under the name Hydrocerol™ (a product and trademark of Clariant). All of these chemical blowing agents may be used as single components or any mixture of combination thereof, or in mixtures with other co-blowing agents.

Additional teachings related to preferred propylene polymers and copolymers, and incorporated herein by reference, may be found in U.S. Pat. No. 5,567,742 at column 1, line 61 through column 2, line 55.

U.S. Pat. No. 6,844,055 teaches preparation of foamable compositions at column 14, lines 23 through 47. U.S. Pat. No. 6,844,055 further teaches foam expansion following foamable composition extrusion at column 15, lines 13-30 and conventional post-extrusion treatments at column 15, lines 31 through 38. The foregoing teachings from U.S. Pat. No. 6,844,055 are modified to relate to solid foam strands, but are otherwise incorporated herein to the maximum extent allowed by law.

The extrusion end plates of the present invention are particularly useful when the polymer melt composition is a foamable polymer composition that contains a blowing agent that has a low solubility relative to a hydrochlorofluorocarbon such as 1-chloro-1,1-difluoroethane (HCFC-142b) or a hydrofluorocarbon such as 1,1,1,2-tetrafluoroethane (HFC-134a). Such nominally “low solubility” blowing agents include, among others, carbon dioxide, nitrogen and argon. Use of a “low solubility” blowing agent requires a high die plate pressure or high extruder back pressure in order to maintain the blowing agent in solution and substantially preclude foaming before a foamable polymer composition exits a die plate, otherwise known as “prefoaming”.

A “high” die pressure, as used herein, means an extruder back pressure at least as high as 800 psi (5.5 MPa). The die plates of the present invention, as shown below, withstand such high die pressures without die plate distortion or bowing, either of which typically leads to creation of fractures between apertures or along a line of apertures.

Prepare conventional flat or planar extrusion end plate of AISI 4140 Rc 32-34 steel with a perforated or foamable melt aperture area that measures 24 inches (in.) (61 centimeters (cm)) by 6 in. (15.2 cm) with a thickness of 0.88 in. (2.2 cm) that is milled to a thickness of 0.25 in. (0.64 centimeter (cm)). Each perforation is circular with a diameter of 0.042 in. (1.1 millimeter (mm)) and an axis that is normal to major planar die surfaces. The perforations are arranged within a rectangular area in a hexagonal close-packed array of 43 rows of 147 apertures and with a spacing between apertures of 0.16 in. (4.06 mm). In a hexagonal close-packed array, adjacent rows are shifted relative to each other by 0.08 in. (2.03 mm) such that each aperture has an axis that is equidistant from that of each adjacent aperture. The foamable melt aperture area is bounded on all sides by an integral flange portion of the end plate that has a width of 1.4 in. (3.6 cm) and a thickness of 0.88 in. (2.2 cm). The flange portion has defined therein a plurality of apertures sized to allow externally threaded cap screws to pass through the apertures in order to secure the end plate to an extruder.

Secure the flat extrusion die plate to a die body that is connected to that end of a 4.75 in. (12.1 cm) transfer line that supplies a foamable mixture at a temperature sufficient to allow foaming to occur as the foamable mixture exits the die plate, and at a pressure sufficient to keep the blowing agent in solution with the polymer in the foamable mixture until the foamable mixture exits the die plate. The transfer line is connected to an extrusion system from which foamable mixture flows. The extrusion system, similar to that of U.S. Pat. No. 6,251,319, the teachings of which are incorporated herein, comprises, in sequential order, a 6 in. (15.2 cm) extruder, a mixer, a cooler and a die body that holds the extrusion die plate. One skilled in the art will recognize that alternative mixing devices for the polymers and blowing agents are possible as well as alternative cooling devices for cooling the foamable mixtures to a temperature suitable for extruding through the dies of this invention. As will also be recognized by those of skill in the art in light of the disclosure herein, multiple dies may be incorporated into the extrusion system such that a foamable mixture may be formed into one or more different shapes before the polymer finally exits the extrusion system in the desired form. For example, one embodiment of the invention is to position a transition die in between the cooler and the end die that is used for the final shaping of the extruded polymer. Such transition die could comprise the extrusion die end plate of this invention, or could be any other sort of extrusion die as long as at least one of the dies used in the extruder system comprises the extrusion die end plate of this invention.

Convert 100 parts by weight (pbw) polypropylene resin (PF814, Basell), 0.5 parts by weight per 100 parts by weight of resin (pph) of talc, 0.5 pph calcium stearate, 0.1 pph antioxidant (IRGANOX™ 1010, Ciba) and 6.5 pph isobutane blowing agent to a foamable polymer melt by operating the extruder under conditions sufficient to convert the named ingredients to a foamable mixture with a cooler exit temperature of 155 degrees centigrade (° C.) to 165° C.

Measure extruder back pressure with a pressure transducer, as supplied by Dynisco, model number E242-3M.

Within five (5) minutes after initiating flow of foamable polymer melt through the flat extrusion die plate, the perforated area begins to bow outward and fractures appear along an outer row of the apertures. Reducing the height from 6 in. (15.2 cm) to 3 in. (7.6 cm), but maintaining the same die back pressure, does not eliminate problems with the die plate as the 3 in. (7.6 cm) high die plate still bows out in response to the die back pressure, thereby rendering the die plate useless.

Prepare a first integral resin extrusion end plate representative of the present invention and similar to that illustrated in FIGS. 1 and 2 by milling a plate with an area for the foamable polymer melt apertures that measures 22 in. (55.9 cm) in width, 3 in. (7.6 cm) in height and 1.06 in. (2.7 cm) in thickness to provide an arcuate perforated area with a thickness of 0.75 in. (1.9 cm). The arcuate area has a radius of curvature on that side of the die plate that abuts the transfer line (also referred to as the “inlet side” of the die) of 5.75 in. (14.6 cm) and a radius of curvature on that side of the die plate spaced apart from the transfer line (also referred to as the “outlet side” of the die of 5.0 in. (12.7 cm). Each radius of curvature is drawn from a common center of radius that is spaced 4.69 in (11.9 cm) away from a plane that includes all planar flange surfaces on the exit side of the die. The arcuate perforated area is bounded on all sides by an integral, planar flange portion of the end plate that has a width of 1.4 in. (3.6 cm) and a thickness of 0.875 in. (2.2 cm). The planar flange portion has defined therein apertures for externally threaded cap screws like those of the flat extrusion die plate to allow the end plate to be secured to the end of the extruder or transfer line in the same manner as the flat extrusion die plate. The perforated area has a similar pattern of apertures as the flat die plate and the apertures have axes that parallel one another in the same manner as the axes of the flat extrusion die plate. The arcuate area is convex when viewed from that end of the extruder into which solid ingredients are fed and concave when viewed from that end of the extruder from which the foamable polymer melt exits. The inlet side and outlet side of the die plate may, and preferably do, have the same center of curvature, with the radius of curvature differing by the thickness of the plate section containing the apertures for the polymer melt.

Prepare a second integral resin extrusion end plate of the present invention similar to that shown in FIG. 3 in the same manner as the first and with the same radii of curvature and center of curvature as the first, but mill the apertures in the perforated area so they are parallel to each other and normal to the plane of the flange.

The first and second integral resin extrusion plates, while smaller in size and perforated area than the planar extrusion end plate, are capable of operating at the extruder back pressure that bow and fracture the flat or planar extrusion end plate. Modeling data as listed in Tables 1 and 2 suggest that increasing the size of the first and second integral resin extrusion plates to match that of the planar extrusion end plate will not adversely affect the capability of such first and second integral resin extrusion plates of the present invention to operate without bowing or fracture at the extruder back pressure that fractures the flat or planar extrusion end plate.

TABLE 1

| Model | |
|---|---|
| Designation | Model Description |
| A | 30.0 in. (76.2 cm) wide by 3.5 in. (8.9 cm) high by 0.25 in. (0.64 cm) thick, |
| | flat plate die, holes having an axis normal to the die plate planar surface, |
| | exit hole 25 having a diameter of 0.04 in. (0.1 cm.), without countersink |
| | segment 22 or aperture 20. |
| B | 24.0 in. (61 cm) wide by 7.0 in. (17.8 cm) high by 0.25 in. (0.64 cm) thick, |
| | flat plate die, holes having an axis normal to the die plate planar surface, |
| | exit hole 25 having a diameter of 0.04 in. (0.1 cm.), without countersink |
| | segment 22 or aperture 20. |
| 1 | 24.0 in. (61 cm) wide by 7.0 in. (17.8 cm) high by 0.75 in. (1.9 cm) thick, |
| | curved plate die, center of radius 5.0 in. (12.7 cm.) from flange exit face, |
| | holes having an axis normal to the closest planar surface as in FIG. 3, exit |
| | hole 25 having a diameter of 0.0465 in. (0.12 cm.) |
| 2 | 22.0 in. (55.9 cm) wide by 3.5 in. (8.9 cm) high by 0.75 in. (1.9 cm) thick, |
| | curved plate die, center of radius 1.0 in. (2.5 cm.) from flange exit face, |
| | holes having an axis normal to the closest planar surface as in FIG. 3, exit |
| | hole 25 having a diameter of 0.047 in. (0.1 cm.), aperture 20 having a |
| | diameter of 0.15 in. (0.4 cm). |
| 3 | 22.0 in. (55.9 cm) wide by 3.5 in. (8.9 cm) high by 0.25 in. (0.64 cm) thick, |
| | curved plate die, center of radius 1.0 in. (2.5 cm.) from flange exit face, |
| | holes having an axis normal to the closest planar surface as in FIG. 3, exit |
| | hole 25 having a diameter of 0.04 in. (0.1 cm.), without countersink |
| | segment 22 or aperture 20. |
| 4 | 24.0 in. (61 cm) wide by 7.0 in. (17.8 cm) high by 0.25 in. (0.64 cm) thick, |
| | curved plate die, center of radius 5.0 in. (12.7 cm.) from flange exit face, |
| | holes having an axis normal to the closest planar surface as in FIG. 3, exit |
| | hole 25 having a diameter of 0.04 in. (0.1 cm.), without countersink |
| | segment 22 or aperture 20. |

Prepare a third integral resin extrusion end plate of the present in the same manner as the first, but the thickness is modified to provide an arcuate perforated area with a thickness of 0.75 in. (1.9 cm). The arcuate area has a radius of curvature on inlet side of the die plate of 3.1 in. (7.9 cm) and a radius of curvature on the outlet side of the die plate of 2.3 in. (5.8 cm). Each radius of curvature is drawn from a common center of radius that is spaced 1.7 in (4.3 cm) away from a plane that includes all planar flange surfaces on the exit side of the die. Mill the apertures in a radial pattern such that axes of the apertures in a single column converge toward the common center of radius. Again, after operating the extruder at the same back pressure, the end plate does not bow or show any signs of fracture or other deformation between adjacent apertures or along a line of apertures.

The maximum von Mises stress of a die design is a triaxial stress value calculated according to distortion-energy theory, as described by Shigley and Mischke in Machine Engineering Design, 5th Edition, pp 172-173 and 244-247 (incorporated herein by reference). The von Mises stress is used to compare to the tensile strength of a material when loaded and is used to estimate yield criteria for ductile materials. The von Mises stress is a conservative value if used to predict that yielding will occur wherever the distortion energy in a unit volume equals the distortion energy in the same volume when uniaxially stressed to the yield strength.

By determining the von Mises stress of a particular die design with an expected load, and by knowing the yield stress of the material of construction of the die plate, one skilled in the art can compare the two values to determine if failure of the die plate may occur. If the value of the von Mises stress is within 50% of the yield stress of the die plate yield stress value, the design may need to be altered. Typically, a mechanical design should have a safety factor of at least two, and more preferably five. The stress at yield of the die plate should be at least two to five times the maximum expected stress (von Mises stress) on the plate. Safety factors less than two may not be considered to be well designed dies. To increase the safety factor of the die design, one can easily increase the thickness, or flow direction dimension, of the die plate. This will typically increase the stress needed to deform a die plate, but in doing so, the shear heating of the polymer mixture flowing through the die will increase, as well as increase the pressure on the extruder and any other devises in the polymer flow path. An increase in shear heating of the polymer mixture may be detrimental to the polymer mixture, increasing the likeliness of degradation of the polymer or some component of the mixture due to increased localized heating. Additionally, the increase in the bulk temperature of the polymer mixture due to the additional shear heating will require more cooling energy, or more cooling time, to stabilize the mixture. The increase in temperature of the extruded material may also lead to a degradation of the foam properties, potentially increasing the open cell content of the foam, or increasing the likeliness of foam collapse.

Table 2 below presents von Mises stress data for the die plates shown in Table 1 above.

TABLE 2

| Model | Load Stress | Maximum von Mises Stress |
|---|---|---|
| Designation | (psi/MPa) | (psi/MPa) |
| A | 200/1.38 | 67,751/467.12 |
| A | 800/5.52 | 271,000/1,868.46 |
| B | 200/1.38 | 459,303/3,166.76 |
| 1 | 200/1.38 | 16,219/111.82 |
| 1 | 800/5.52 | 64,876/447.30 |
| 1 | 1,600/6.31 | 129,752/894.60 |
| 2 | 200/1.38 | 2,392/16.49 |
| 2 | 800/5.52 | 9,570/65.98 |
| 2 | 1,000/6.89 | 11,960/82.46 |
| 3 | 200/1.38 | 16,725/115.31 |
| 3 | 800/5.52 | 66,900/461.25 |
| 3 | 1,540/10.62 | 129,000/889.42 |
| 4 | 200/1.38 | 31,012/213.82 |
| 4 | 800/5.52 | 124,050/855.29 |
| 4 | 830/5.72 | 129,000/889.42 |

The die plates are all fabricated from a material with a yield strength of 130,000 pounds per square inch (psi)/896 megapascals (MPa). The data in Table 2 at least partially explain why die plate failure occurs with flat die plates (Models A and B) whereas arched or curved die plates (Models 1 through 4) do not experience die plate failure through mechanisms such as bowing, cracking or fracture at substantially higher loadings (extruder back pressures) than those at which flat die plates undergo die plate failure. The von Mises stresses are linear with respect to Load Stress, until the von Mises stress matches the yield stress, or yield strength, of the material.

Similar results are expected with other integral resin extrusion end plates that fall within the scope of the appended claims and the specifications presented hereinabove.

Operating at the same extruder back pressure, none of the first, the second, or the third integral extrusion end plates bow and an examination of the plates after extrusion reveals no fractures or other deformations between adjacent apertures or along a line of apertures.

Similar results are expected with filled polymer melt compositions and polymer melts that comprise a thermoplastic polymer and a fibrous organic material.

Other embodiments of the invention will be apparent to those skilled in the art from a consideration of this specification or practice of the invention disclosed herein, including extrapolation of the examples set forth in the specification. It is intended that the specification and examples be considered as exemplary only, with the true scope and spirit of the invention being indicated by the following claims.

1. An integral resin extrusion end plate for an extruded polymer melt strand die, the end plate having a first or polymer melt receiving major surface and, spaced apart from and generally parallel to the first major surface, a second or polymer melt discharge major surface, the first and second major surfaces having defined therein a perimeter flange segment that surrounds a radially arcuate segment, each major surface of the radially arcuate segment having a radius of curvature drawn from a center of radius spaced apart from the end plate and, relative to the major surfaces, closer to the second major surface than the first major surface, the radially arcuate segment having defined therein a plurality of polymer melt apertures each of which is in fluid communication with both the first and second major surfaces.

2. The end plate of claim 1, wherein the perimeter flange portion is a rectangle.

3. The end plate of claim 2, wherein the radially arcuate segment is, relative to the die plate as a whole, a hollow right circular cylinder.

4. The end plate of claim 1, wherein the polymer melt apertures are arranged in a geometric array.

5. (canceled)

6. The end plate of claim 4, wherein the plate has a length of from 3 inches (in.) (7.6 centimeters (cm)) to 48 in. (121.9 cm), a width of from 0.5 in. (1.3 cm) to 9 in. (22.9 cm), and a thickness of from 0.125 in. (0.3 cm) to 1.5 in. (3.8 cm).

7. The end plate of claim 1, wherein the perimeter flange portion is either a circle, an ellipse, or a polygon other than a rectangle.

8. (canceled)

9. The end plate of claim 4, wherein the geometric array is a semi-regular configuration.

10. An integral resin extrusion end plate for an extruded polymer melt strand die, the end plate having a second or polymer melt discharge major surface that is fully planar with a planar perimeter flange section that surrounds a planar perforated segment, and, spaced apart from the second major surface, a first or polymer melt receiving major surface that has a perimeter flange portion that surrounds a convex perforated segment, perforations in the perforated segments having defined therein a plurality of polymer melt apertures that are in fluid communication with both the first and second major surfaces.

11. An integral resin extrusion end plate for an extruded polymer melt strand die, the end plate having a first, polymer melt receiving major surface and, spaced apart from the first major surface, a second, polymer melt discharge major surface, the first and second major surfaces having defined therein a perimeter flange segment that surrounds a radially arcuate segment, each major surface of the radially arcuate segment having a common radius of curvature but a different center of radius, the center of radius for the first, polymer melt receiving surface being closer to the second, polymer melt discharge surface than the center of radius for the second, polymer melt discharge surface, the radially arcuate segments having defined therein a plurality of polymer melt apertures each of which is in fluid communication with both the first and second major surfaces.

12. An integral resin extrusion end plate for an extruded polymer melt strand die, the end plate having a first, polymer melt receiving major surface and, spaced apart from the first major surface, a second, polymer melt discharge major surface, the first and second major surfaces having defined therein a perimeter flange segment that surrounds a radially arcuate segment, each major surface of the radially arcuate segment having a radius of curvature drawn from a common center of radius, the radius of curvature for the second major surface being constant and the radius of curvature for the first major surface varying from a minimum at both ends of the radially arcuate segment to a maximum at the radially arcuate segment's center point, the radially arcuate segments having defined therein a plurality of polymer melt apertures each of which is in fluid communication with both the first and second major surfaces.

13. (canceled)

14. (canceled)

15. (canceled)

16. (canceled)

17. An article of manufacture comprising a filled thermoplastic polymer material or a composition comprising a fibrous material and a thermoplastic polymer, the article of manufacture being prepared using the end plate of claim 1.

18. The article of manufacture of claim 17 wherein the fibrous material comprises organic fibrous material.

19. An extrusion system for forming an extruded polymer strand foam material, comprising in connected, sequential, order:
a. an extruder to extrude a polymer melt;
b. a mixing device for adding a blowing agent to form a foamable mixture;
c. a cooling device to cool the foamable mixture; and
d. a die body comprising the end plate of any of claims 1-12 for forming the polymer strand foam material from the foamable mixture.

20. The extruder system of claim 19 further comprising at least one transition die positioned in between the cooling device and the end plate, such transition die comprising an aperture to receive the foamable mixture and form it into an initial shape and to extrude the formed mixture.

21. The end plate of claim 1, wherein the perimeter flange has defined therein a plurality of mounting apertures.

22. The end plate of claim 1, wherein the polymer melt apertures include a flared segment and a main bore such that the flared segment is connected into one end of the main bore.
